(19) United States
(12) Patent Application Publication
(10) Pub. No.: US 2018/0352010 A1
(43) Pub. Date: Dec. 6, 2018

(54) COMMUNICATION SYSTEM, COMMUNICATION APPARATUS, AND COMMUNICATION METHOD

(71) Applicant: DENSO TEN Limited, Kobe-shi (JP)

(72) Inventor: Tadashi SAKAGUCHI, Kobe-shi (JP)

(73) Assignee: DENSO TEN Limited, Kobe-shi (JP)

(21) Appl. No.: 15/903,467

(22) Filed: Feb. 23, 2018

(30) Foreign Application Priority Data
Jun. 6, 2017 (JP) 2017-112069

(51) Int. Cl. H04L 29/06; H04W 76/11; H04W 60/04

(52) U.S. Cl. CPC H04L 65/1073; H04W 4/70; H04W 60/04; H04W 76/11

(57) ABSTRACT

There is provided a communication system. A superordinate unit configured to transmit a registration instruction command instructing that identifier registration. Subordinate units configured to be connected to the superordinate unit such that communication is possible and to register identifiers corresponding to the registration instruction command, into the superordinate unit. Each of the subordinate units includes a creating unit configured to create an identifier corresponding to the registration instruction command, an instructing unit configured to instruct the creating unit to create another identifier, if a registration request command is received from another subordinate unit before a registration request command including the identifier created by the creating unit is transmitted to the superordinate unit, and a transmitting unit configured to transmit the registration request command including the identifier created by the creating unit to the superordinate unit.

### CROSS-REFERENCE TO RELATED APPLICATIONS

This application is based on and claims priority under 35 USC 119 from Japanese Patent Application No. 2017-112069 filed on Jun. 6, 2017.

### TECHNICAL FIELD

The present disclosure relates to a communication system, a communication apparatus, and a communication method.

### BACKGROUND

In the related art, for example, a communication system which is configured by connecting a master ECU (Electronic Control Unit) which is a superordinate unit and slave ECUs which are subordinate units on an in-vehicle network such that communication is possible is known. In this communication system, the superordinate unit creates identifiers identifying the subordinate units, and notifies the identifiers to the subordinate units, whereby the identifiers are given to the subordinate units (see Japanese Patent Application Laid-Open No. 2005-341386 for instance).

However, the above-described communication system according to the related art has a problem that in the case of changing the number of connections of subordinate units, updating of software of the superordinate unit, updating of setting information of the superordinate unit, and so on are required, and thus manual updating is required.

### SUMMARY

It is therefore an object of the present invention to provide a communication system, a communication apparatus, and a communication method capable of performing assignment of identifiers to subordinate units, without performing manual updating.

According to an aspect of the disclosure of the present invention, there is provided a communication system including: a superordinate unit configured to transmit a registration instruction command instructing that identifier registration; and subordinate units configured to be connected to the superordinate unit such that communication is possible and to register identifiers corresponding to the registration instruction command, into the superordinate unit. Each of the subordinate units includes: a creating unit configured to create an identifier corresponding to the registration instruction command; an instructing unit configured to instruct the creating unit to create another identifier, if a registration request command is received from another subordinate unit before a registration request command including the identifier created by the creating unit is transmitted to the superordinate unit; and a transmitting unit configured to transmit the registration request command including the identifier created by the creating unit to the superordinate unit.

A communication system, a communication apparatus, and a communication method according to an embodiment can perform assignment of identifiers to subordinate units, without performing manual updating.

### BRIEF DESCRIPTION OF THE DRAWINGS

Exemplary embodiments of the present invention will be described in detail based on the following figures, wherein:

FIG. 1A is a view for explaining an outline of a communication method according to an embodiment;

FIG. 1B is a view for explaining the outline of the communication method according to the embodiment;

FIG. 2 is a block diagram illustrating an example of the configuration of a communication system according to the embodiment;

FIG. 3A is a sequence diagram illustrating an example of an ID registering process which is performed by the communication system according to the embodiment;

FIG. 3B is a sequence diagram illustrating another example of the ID registering process which is performed by the communication system according to the embodiment;

FIG. 4 is a flow chart illustrating a first part of a processing procedure which is performed by the communication system according to the embodiment;

FIG. 5 is a flow chart illustrating a second part of the processing procedure which is performed by the communication system according to the embodiment; and

FIG. 6 is a view illustrating a configuration example of a communication system according to the embodiment.

### DETAILED DESCRIPTION

Hereinafter, an embodiment of a communication system, a communication apparatus, and a communication method according to the present invention will be described in detail with reference to the accompanying drawings. However, the present invention is not limited by the following embodiment.

Also, in the present embodiment, the case where the communication system is a communication system installable in a vehicle and including a battery pack monitoring apparatus will be described as an example. In the communication system includes a master ECU (Electronic Control Unit) which is a superordinate unit for monitoring a battery pack composed of battery blocks connected in series, and slave ECUs which are subordinate units for monitoring the battery blocks each having battery cells connected in series. However, the communication system is not limited to a system installable in a vehicle, and may be installed in an indoor or outdoor location.

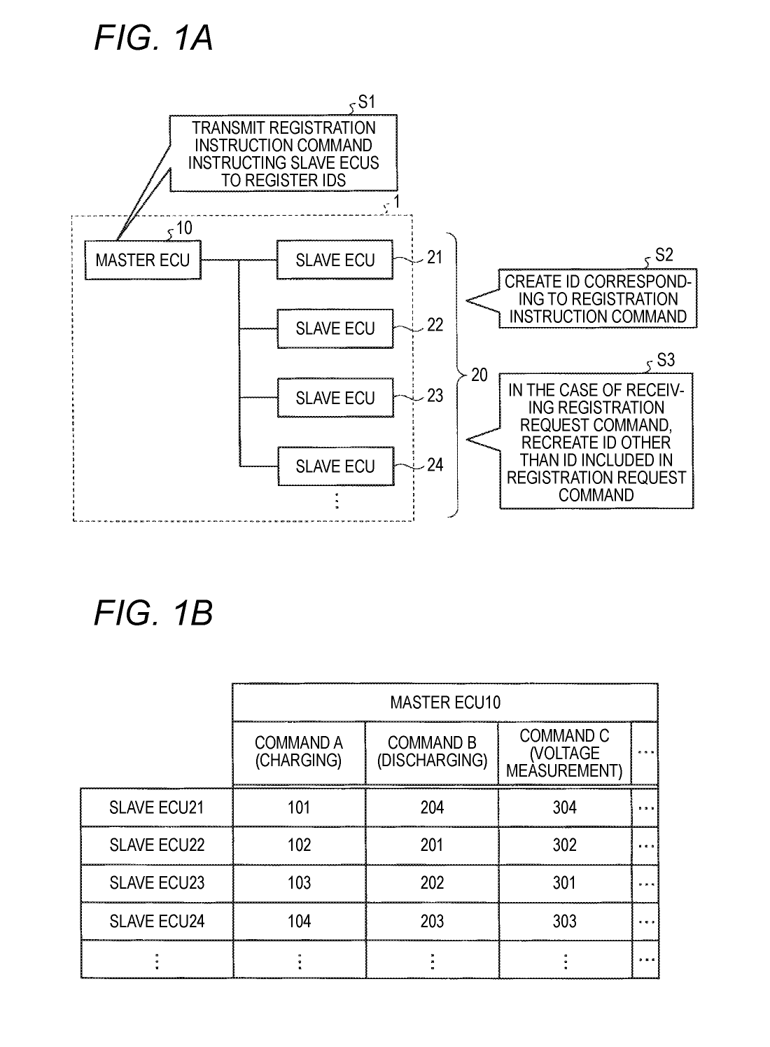

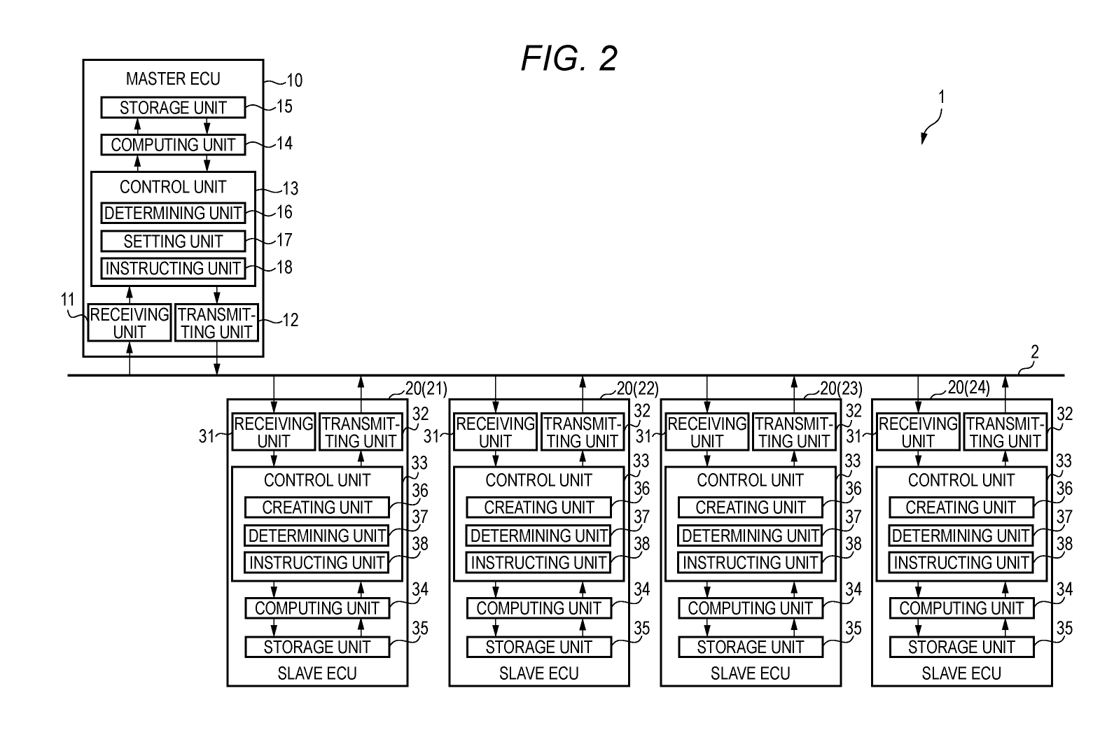

Also, hereinafter, an outline of a communication method according to the present embodiment will be described first with reference to FIG. 1A and FIG. 1B, and then a communication apparatus and a communication system including the communication apparatus will be described with reference to FIG. 2 to FIG. 6.

First, an outline of the communication method according to the present embodiment will be described with reference to FIG. 1A and FIG. 1B. FIG. 1A and FIG. 1B are views for explaining the outline of the communication method according to the embodiment.

As shown in FIG. 1A, a communication system 1 includes a master ECU 10, and slave ECUs 20 (in FIG. 1A and FIG. 1B, slave ECUs 21, 22, 23, and 24) connected to the master ECU 10 such that communication is possible.

Here, with respect to each of commands corresponding to monitoring contents, the communication system 1 assigns IDs (Identifications) which are identifiers identifying the individual slave ECUs 20, to the individual slave ECUs 20. Also, as commands corresponding to monitoring contents, as shown in FIG. 1B, for example, there are a command A corresponding to charging, a command B corresponding to discharging, and a command C corresponding to voltage measurement, and so on.

For example, as shown in FIG. 1B, in the case where a command corresponding to a monitoring content is the command A corresponding to charging, the master ECU 10 assigns “101”, “102”, “103”, and “104” as IDs to the individual slave ECUs 20, respectively. In short, IDs which are assigned to the slave ECUs 20 are mutually exclusive IDs.

Also, in the case where a command corresponding to a monitoring content is the command B corresponding to discharging, the master ECU 10 assigns “201”, “202”, “203”, and “204” as IDs to the individual slave ECUs 20, respectively. Further, the individual IDs corresponding to the command B have an exclusive relationship with the individual IDs corresponding to the command A. Also, in FIG. 1B, in order to facilitate understanding, a table is shown; however, precisely, the master ECU 10 does not assign IDs associated with the individual slave ECUs 20 to the slave ECUs, and just recognizes that the four slave ECUs exit according to the number of IDs of the same type, such as “101” to “104” or “201” to “204”.

By the way, in the communication system of the related art, the master ECU creates IDs to be given to the slave ECUs, on the basis of setting information and the like prepared in advance, and notifies the created IDs to the individual slave ECUs. In other words, in the communication system of the related art, the master ECU assigns IDs to the individual slave ECUs according to each monitoring content, for example, on the basis of a table or the like defining commands corresponding to monitoring contents and IDs corresponding to the commands.

Therefore, in the communication system of the related art, in some cases, such as the case of changing the number of connections of slave ECUs, updating of software of the master ECU, updating of setting information of the master ECU, and so on are required.

For this reason, the communication system 1 according to the present embodiment is configured such that the individual slave ECUs 20 create IDs by themselves and the individual slave ECUs 20 register the created IDs in the master ECU 10.

Specifically, as shown in FIG. 1A, first, the master ECU 10 transmits a registration instruction command for instructing the slave ECUs to register IDs in the master ECU 10, to the individual slave ECUs 20 (STEP S1). Then, the individual slave ECUs 20 having received the registration instruction command create IDs (STEP S2), and try to transmit registration request commands including the created IDs.

By the way, each slave ECU 20 may receive a registration request command from any other slave ECU 20 before transmitting a registration request command. In this case, the corresponding slave ECU 20 considers that an ID included in the received registration request command has been registered in the master ECU 10, and prohibits the corresponding slave ECU from transmitting the corresponding ID. In other words, in the case where a slave ECU 20 receives a registration request command from any other slave ECU 20, it recreates an ID other than an ID included in the received registration request command (STEP S3).

Then, each slave ECU 20 repeats ID recreation until transmission of a created ID succeeds. In this way, exclusive IDs are assigned to all slave ECUs 20.

In short, even in the case where the number of slave ECU 20 is changed, the communication system 1 according to the present embodiment can automatically assign exclusive IDs to the individual slave ECUs 20. In other words, according to the communication system 1, even if the number of slave ECUs 20 is changed or replacement of some slave ECUs is performed, it is possible to perform assignment of IDs to slave ECUs 20, without performing manual updating.

Now, with reference to FIG. 2, the configuration of the communication system 1 according to the embodiment will be described. FIG. 2 is a block diagram illustrating an example of the configuration of the communication system 1 according to the embodiment. In FIG. 2, only components necessary to explain features of the present embodiment are shown by functional blocks, and general components are not shown.

In other words, the components shown in FIG. 2 are functionally conceptual, and do not need to have a physically configuration as shown in FIG. 2. For example, distribution or integration of the individual functional blocks is not limited to a specific mode shown in FIG. 2, and it is possible to distribute or integrate all or a part thereof functionally or physically in an arbitrary unit, depending on various loads, usage conditions, and so on.

As shown in FIG. 2, in the communication system 1 according to the embodiment, the master ECU 10 and the slave ECUs 20 (in FIG. 2, the slave ECUs 21, 22, 23, and 24) are connected via a communication line 2 such that communication is possible. Also, in the communication system 1 of this example, one master ECU 10 manages the four slave ECUs 21, 22, 23, and 24.

First, the master ECU 10 will be described. The master ECU 10 includes a receiving unit 11, a transmitting unit 12, a control unit 13, a computing unit 14, and a storage unit 15.

The receiving unit 11 is a processing unit for receiving registration request commands including IDs from the individual slave ECUs 20 via the communication line 2. The transmitting unit 12 is a processing unit for transmitting a registration instruction command instructing the slave ECUs to register IDs, and a registration completion command representing completion of registration of the IDs of the individual slave ECUs 20, to the individual slave ECUs 20, via the communication line 2.

The control unit 13 is a processing unit which includes, for example, an FPGA (Field Programmable Gate Array), a microcomputer, and so on and controls various processes of the master ECU 10. The control unit 13 includes a determining unit 16, a setting unit 17, and a instructing unit 18.

The determining unit 16 is a processing unit for determining whether an ID registering process has been performed on the individual slave ECUs 20. The setting unit 17 is a processing unit for setting a time from start of reception of registration request commands to end of reception. The instructing unit 18 is a processing unit for instructing the transmitting unit 12 to transmit a registration instruction command and a registration completion command. Also, the time from start of reception to end of reception which is set by the setting unit 17 is set in advance in view of the maximum number of slave ECUs 20 assumed to be connected to the master ECU 10. If the number of slave ECUs 20 is fixed and other slave ECUs 20 are not added, a time corresponding to the corresponding number may be set.

Therefore, after a registration instruction command is transmitted to the slave ECUs 20, if the preset time corresponding to the number of slave ECUs 20 elapses, the instructing unit 18 instructs the transmitting unit 12 to transmit a registration completion command to the slave ECUs 20.

The computing unit 14 is a processing unit which includes, for example, a CPU (Central Processing Unit) and performs various processes of the master ECU 10.

The storage unit 15 includes, for example, a semiconductor memory device, such as a ROM (Read Only Memory), a RAM (Random Access Memory), or a flash memory, an HDD (Hard Disk Drive), an optical disk, or the like. The storage unit 15 is a processing unit for storing IDs included in registration request commands received by the receiving unit 11. Also, the storage unit 15 retains the time set in advance in view of the maximum number of slave ECUs 20 assumed to be connected to the master ECU 10, as a threshold.

Now, the slave ECUs 20 will be described. However, since the individual slave ECUs 20 have the same configuration and functions, the slave ECU 21 of the individual slave ECUs 20 will be described. Also, components of the other slave ECUs 22, 23, and 24 identical to components of the slave ECU 21 are denoted by the same reference symbols, and a description thereof will not be made.

The slave ECU 21 includes a receiving unit 31, a transmitting unit 32, a control unit 33, a computing unit 34, and a storage unit 35.

The receiving unit 31 is a processing unit for receiving registration instruction commands and registration completion commands from the master ECU 10 via the communication line 2. The transmitting unit 32 is a processing unit for transmitting registration request commands including IDs created by a creating unit 36 (to be described below) to the master ECU 10 via the communication line 2. Also, the transmitting unit 32 repeatedly transmits registration request commands including IDs created by the creating unit 36. Also, the receiving unit 31 receives registration request commands including IDs from the other slave ECUs 22 to 24.

The control unit 33 is a processing unit which includes, for example, an FPGA, a microcomputer, and so on and controls various processes of the slave ECU 21. The control unit 33 includes the creating unit 36, a determining unit 37, and an instructing unit 38.

The creating unit 36 is a processing unit for creating IDs corresponding to registration instruction commands. Specifically, in the case where a registration instruction command instructing the slave ECUs to register IDs corresponding to the command A corresponding to charging is received by the receiving unit 31, the creating unit 36 sequentially creates for example, serial numbers from 101, as IDs according to the received registration instruction command.

Also, in the case where a registration instruction command instructing the slave ECUs to register IDs corresponding to the command B corresponding to discharging is received by the receiving unit 31, the creating unit 36 sequentially creates, for example, serial numbers from 201, as IDs according to the received registration instruction command.

In short, in the case where a registration instruction command instructing the slave ECUs to register IDs corresponding to a command corresponding to a monitoring content is received by the receiving unit 31, the creating unit 36 sequentially creates preset serial numbers as IDs at intervals of a predetermined time, for example, by counting up of a counter or the like.

The determining unit 37 is a processing unit for determining whether a registration instruction command instructing the slave ECUs to register IDs has been received from the master ECU 10.

Also, before a registration request command including a created ID is transmitted to the master ECU 10, the determining unit 37 determines whether a registration request command has been received from any other slave ECU 22, 23, or 24. Further, the determining unit 37 determines whether a registration completion command representing completion of ID registration has been received.

Also, the determining unit 37 determines whether an ID created for transmission by the slave ECU 22 is the same as an ID included in a registration request command received from any other slave ECU 22, 23, or 24.

The instructing unit 38 is a processing unit configured such that before a registration request command including a created ID is transmitted to the master ECU 10, if a registration request command is received from any other slave ECU 22, 23, or 24, and the created ID is the same as an ID included in the registration request command received from any other slave ECU 22, 23, or 24, the processing unit instructs the creating unit 36 to create another ID.

Also, in the case where a registration request command including a created ID could be transmitted to the master ECU 10, the instructing unit 38 instructs the transmitting unit 32 to repeatedly transmit the ID which could be transmitted.

Further, the instructing unit 38 instructs the receiving unit 31 to keep on receiving registration request commands from the slave ECUs 22, 23, and 24 until a registration completion command is received.

Furthermore, if a registration completion command representing completion of registration of IDs of the individual slave ECUs 21, 22, 23, and 24 is received, the instructing unit 38 instructs the storage unit 35 to store an ID included in a registration request command transmitted last.

The computing unit 34 is a processing unit which includes, for example, a CPU and performs various processes of the slave ECU 21.

The storage unit 35 includes, for example, a semiconductor memory device, such as a ROM, a RAM, or a flash memory, an HDD, an optical disk, or the like. The storage unit 35 is a processing unit for storing an ID included in a registration request command transmitted last by the transmitting unit 32.

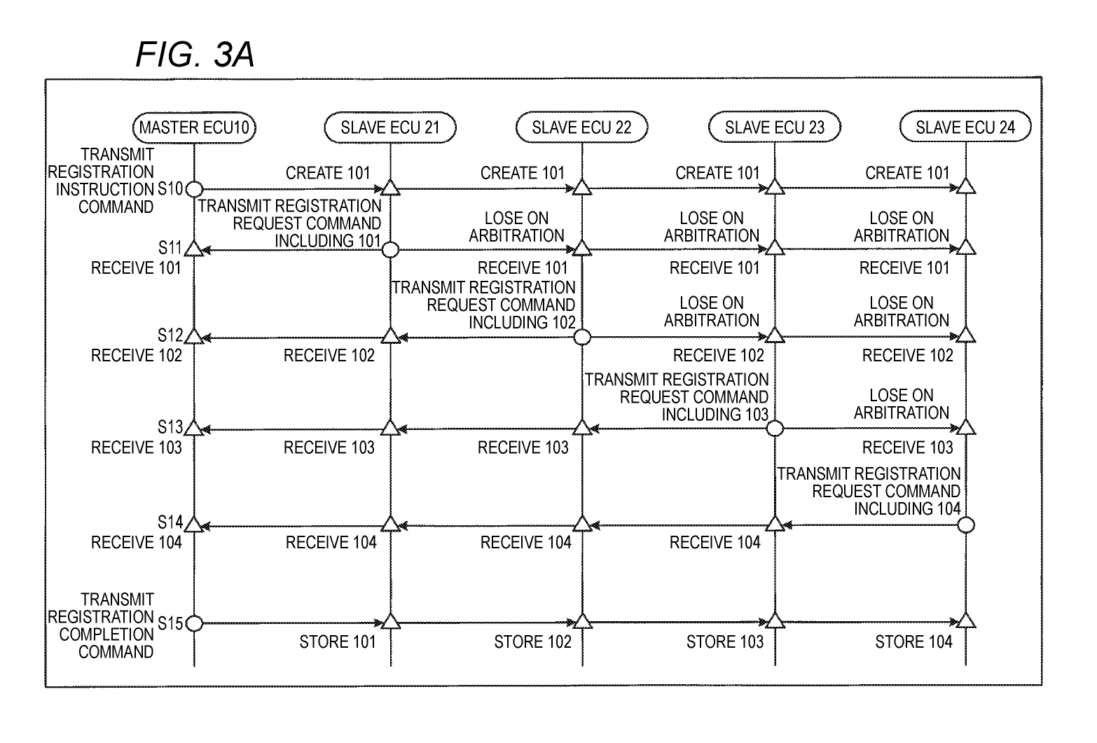

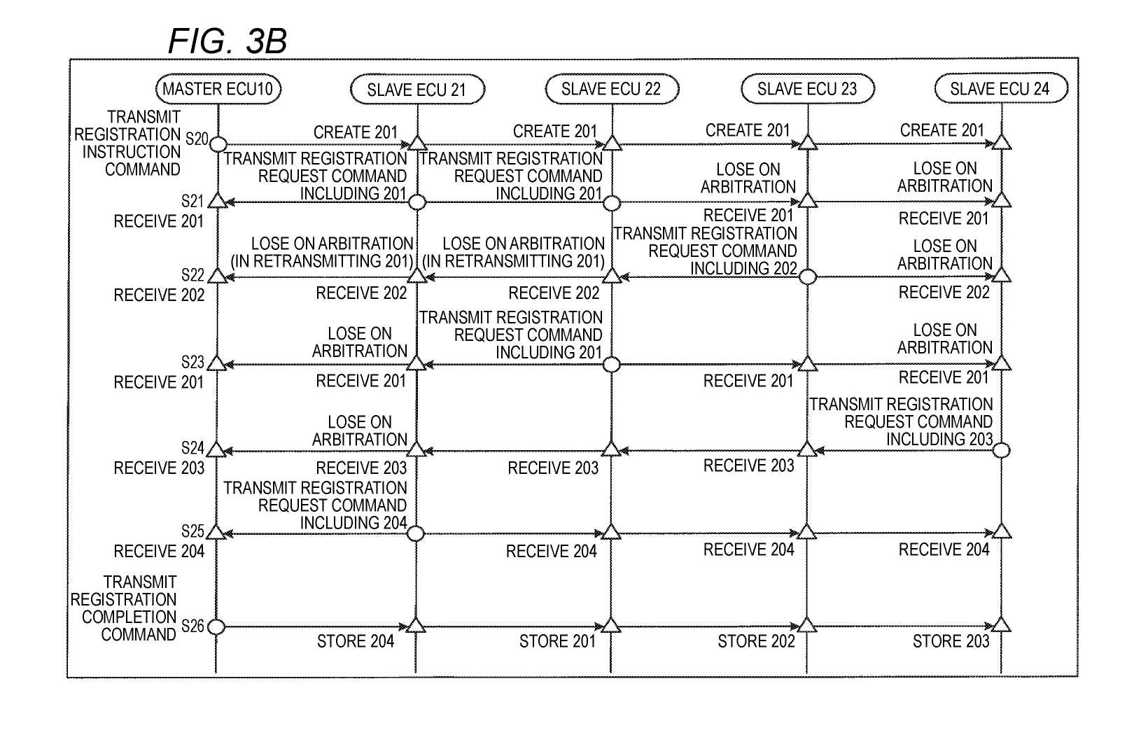

Now, with reference to FIG. 3A and FIG. 3B, an ID registering process which is performed by the communication system 1 according to the embodiment will be described. FIG. 3A and FIG. 3B are sequence diagrams illustrating examples of the ID registering process which is performed by the communication system 1 according to the embodiment.

First, with reference to FIG. 3A, the example in which IDs of the individual slave ECUs 21, 22, 23, and 24 are registered will be described. Specifically, the case where, in response to a registration instruction command instructing the slave ECUs to register IDs corresponding to the command A corresponding to charging, IDs “101” to “104” are registered as IDs of individual slave ECUs 21, 22, 23, and 24 will be described.

As shown in FIG. 3A, first, the master ECU 10 transmits a registration instruction command instructing the slave ECUs to register IDs corresponding to the command A corresponding to charging, to the individual slave ECUs 21, 22, 23, and 24.

If each of the slave ECUs 21, 22, 23, and 24 receives the registration instruction command by the receiving unit 31, it transitions to an ID registration request mode. Subsequently, each of the slave ECUs 21, 22, 23, and 24 creates “101” which is the minimum serial number of the preset serial numbers according to the command A, as an ID (STEP S10).

Next, each of the slave ECUs 21, 22, 23, and 24 tries to transmit a registration request command including “101” to the master ECU 10.

Here, it is assumed that the slave ECU 21 could transmit the registration request command including “101” to the master ECU 10 before the other slave ECUs 22, 23, and 24. In this case, the other slave ECUs 22, 23, and 24 receive the registration request command including “101” from the slave ECU 21 when they are preparing to transmit registration request commands including “101”.

In short, the other slave ECUs 22, 23, and 24 lose on arbitration in transmitting the registration request commands including “101” to the master ECU 10 (STEP S11). Since the IDs prepared for transmission in the other slave ECUs 22, 23, and 24 having lost on arbitration are the same as the ID included in the received registration request command, they create the next serial number “102” as IDs.

Meanwhile, the slave ECU 21 having won on arbitration keeps on retransmitting the registration request command including “101” at regular intervals until a registration completion command is received from the master ECU 10. The master ECU 10 stores information representing that the slave ECU having the ID “101” exists on the network, in the storage unit 15.

Thereafter, the slave ECU 21 keeps on receiving registration request commands transmitted from the other slave ECUs 22, 23, and 24. However, since the slave ECU 21 does not receive the ID “101” from the other slave ECUs 22, 23, and 24, it repeatedly transmits the same ID “101”, i.e. the ID “101” which could be transmitted, without creating any other ID (“102”, “103”, “104”, or the like) by counting up.

Subsequently, each of the slave ECUs 22, 23, and 24 tries to transmit a registration request command including “102” to the master ECU 10.

Here, it is assumed that the slave ECU 22 could transmit the registration request command including “102” to the master ECU 10 before the other slave ECUs 23 and 24. In this case, the other slave ECUs 23 and 24 receive the registration request command including “102” from the slave ECU 22 when they are preparing to transmit the registration request commands including “102”.

In short, the other slave ECUs 23 and 24 lose on arbitration in transmitting the registration request commands including “102” to the master ECU 10 (STEP S12). Since the IDs prepared for transmission in the other slave ECUs 23 and 24 having lost on arbitration are the same as the ID included in the received registration request command, they create the next serial number “103” as IDs.

Meanwhile, the slave ECU 22 having won on arbitration keeps on retransmitting the registration request command including “102” at regular intervals until a registration completion command is received from the master ECU 10. The master ECU 10 stores information representing that the slave ECU having the ID “102” exists on the network, in the storage unit 15.

Thereafter, the slave ECU 22 keeps on receiving registration request commands transmitted from the other slave ECUs 21, 23, and 24. However, since the slave ECU 22 does not receive the ID “102” from the other slave ECUs 21, 23, and 24, it repeatedly transmits the same ID “102”, i.e. the ID “102” which could be transmitted, without creating any other ID (“103”, “104”, or the like) by counting up.

Subsequently, each of the slave ECUs 23 and 24 tries to transmit a registration request command including “103” to the master ECU 10.

Here, it is assumed that the slave ECU 23 could transmit the registration request command including “103” to the master ECU 10 before the other slave ECU 24. In this case, the other slave ECU 24 receives the registration request command including “103” from the slave ECU 23 when it is preparing to transmit the registration request command including “103”.

In short, the other slave ECU 24 loses on arbitration in transmitting the registration request commands including “103” to the master ECU 10 (STEP S13). Since the ID prepared for transmission in the other slave ECU 24 having lost on arbitration is the same as the ID included in the received registration request command, the other slave ECU creates the next serial number “104” as an ID.

Meanwhile, the slave ECU 23 having won on arbitration keeps on retransmitting the registration request command including “103” at regular intervals until a registration completion command is received from the master ECU 10. The master ECU 10 stores information representing that the slave ECU having the ID “103” exists on the network, in the storage unit 15.

Thereafter, the slave ECU 23 keeps on receiving registration request commands transmitted from the other slave ECUs 21, 22, and 24. However, since the slave ECU 23 does not receive the ID “103” from the other slave ECUs 21, 22, and 24, it repeatedly transmits the same ID “103”, i.e. the ID “103” which could be transmitted, without creating any other ID (“104” or the like) by counting up.

Next, the slave ECU 24 tries to transmit a registration request command including “104” to the master ECU 10. Since the other slave ECUs 21, 22, and 23 are continuing to transmit the registration request commands including “101”, “102”, and “103”, respectively, i.e. the registration request commands which do not include “104”, and “104” are not being transmitted from any of the slave ECUs 21, 22, and 23, the slave ECU 24 can transmit the registration request command including the ID “104” to the master ECU 10 (STEP S14).

Therefore, the slave ECU 24 keeps on retransmitting the registration request command including “104” at regular intervals until a registration completion command is received from the master ECU 10. The master ECU 10 stores information representing that the slave ECU having the ID “104” exists on the network, in the storage unit 15.

Thereafter, the master ECU 10 transmits a registration completion command to the individual slave ECUs 21, 22, 23, and 24. Also, if ID registration is completed for all of the slave ECUs 21, 22, 23, and 24 which are managed by the master ECU 10, or if the preset time elapses, the master ECU 10 transmits the registration completion command.

If the individual slave ECUs 21, 22, 23, and 24 receive the registration completion command by the receiving units 31, they store the IDs included in the registration request commands transmitted last in the storage units 35.

In the above-mentioned example, the slave ECU 21 stores “101” in the storage unit 35, and the slave ECU 22 stores “102” in the storage unit 35. Also, the slave ECU 23 stores “103” in the storage unit 35, and the slave ECU 24 stores “104” in the storage unit 35 (STEP S15).

As described above, in response to the registration instruction command instructing the slave ECUs to perform registration corresponding to the command A corresponding to charging, any one ID of the IDs “101” to “104” is assigned to each of the slave ECUs 21, 22, 23, and 24.

Now, with reference to FIG. 3B, another example in which IDs of the slave ECUs 21, 22, 23, and 24 are registered will be described. Specifically, the case where, in response to a registration instruction command instructing the slave ECUs to perform registration corresponding to the command B corresponding to discharging, IDs “201” to “204” are registered as IDs of individual slave ECUs 21, 22, 23, and 24 will be described.

As shown in FIG. 3B, first, the master ECU 10 transmits a registration instruction command instructing the slave ECUs to perform registration corresponding to the command B corresponding to discharging, to the individual slave ECUs 21, 22, 23, and 24.

If each of the slave ECUs 21, 22, 23, and 24 receives the registration instruction command by the receiving unit 31, it transitions to an ID registration request mode. Subsequently, each of the slave ECUs 21, 22, 23, and 24 creates “201” which is the minimum serial number of the preset serial numbers according to the command B, as an ID (STEP S20).

Next, each of the slave ECUs 21, 22, 23, and 24 tries to transmit a registration request command including “201” to the master ECU 10.

Here, it is assumed that the slave ECU 21 and the slave ECU 22 could transmit the registration request commands including “101” to the master ECU 10 at the same time before the other slave ECUs 23 and 24. In this case, the other slave ECUs 23 and 24 receive the registration request commands including “201” and transmitted at the same time from the slave ECU 21 and the slave ECU 22 when they are preparing to transmit the registration request commands including “201”.

In short, the other slave ECUs 23 and 24 lose on arbitration in transmitting the registration request commands including “201” to the master ECU 10 (STEP S21). Since the IDs prepared for transmission in the other slave ECUs 23 and 24 having lost on arbitration are the same as the IDs included in the received registration request commands, the other slave ECUs create the next serial number “202” as their IDs.

Meanwhile, since the slave ECU 21 and the slave ECU 22 having won on arbitration have not received “201” from the other slave ECUs 23 and 24, they try to keep on retransmitting the registration request commands including “201” at regular intervals until a registration completion command is received from the master ECU 10.

Since the master ECU 10 has received the registration request commands including “201”, it stores information representing that the slave ECUs having the ID “201” exist on the network, in the storage unit 15.

Also, the slave ECUs 21 and 22 are supposed to retransmit the registration request commands including “201” without creating any other IDs by counting up.

Subsequently, the slave ECUs 21 and 22 try to retransmit the registration request commands including “201” to the master ECU 10, and the slave ECUs 23 and 24 try to retransmit the registration request commands including “202” to the master ECU 10.

Here, it is assumed that the slave ECU 23 could transmit the registration request command including “202” to the master ECU 10 before the other slave ECUs 21, 22, and 24. In this case, the slave ECUs 21 and 22 receive the registration request command including “202” from the slave ECU 23 when they are preparing to transmit the registration request command including “201”. Also, the slave ECU 22 receives the registration request command including “202” from the slave ECU 23 when it is preparing to transmit the registration request command including “202”.

In short, the slave ECUs 21 and 22 lose on arbitration in transmitting the registration request commands including “201” to the master ECU 10, and the slave ECU 24 loses on arbitration in transmitting the registration request command including “202” to the master ECU 10 (STEP S22). Since the slave ECUs 21 and 22 having lost on arbitration have not received “201” from the other slave ECUs 23 and 24, they are supposed to retransmit the registration request command including “201”. Also, since the ID prepared for transmission in the slave ECU 24 having lost on arbitration is the same as the ID included in the received registration request command, the slave ECU 24 creates the next serial number “203” as an ID.

Meanwhile, the slave ECU 23 having won on arbitration keeps on retransmitting “202” at regular intervals until a registration completion command is received from the master ECU 10. The master ECU 10 stores information representing that the slave ECU having the ID “202” exists on the network, in the storage unit 15.

Thereafter, the slave ECU 23 keeps on receiving registration request commands transmitted from the other slave ECUs 21, 22, and 24. However, since the slave ECU 23 does not receive the ID “202” from the other slave ECUs 21, 22, and 24, it repeatedly transmits the same ID “202”, i.e. the ID “202” which could be transmitted, without creating any other ID (“203”, “204”, or the like) by counting up.

Next, the slave ECUs 21 and 22 try to retransmit the registration request commands including “201” to the master ECU 10, and the slave ECU 24 tries to transmit a registration request command including “203” to the master ECU 10.

Here, it is assumed that the slave ECU 22 could transmit the registration request command including “201” to the master ECU 10 before the other slave ECUs 21 and 23. In this case, the slave ECU 21 receives the registration request command including “201” from the slave ECU 22 when it is preparing to transmit the registration request command including “201”. Also, the slave ECU 24 receives the registration request command including “201” from the slave ECU 22 when it is preparing to transmit the registration request command including “203”.

In short, the slave ECU 21 loses on arbitration in transmitting the registration request command including “201” to the master ECU 10, and the slave ECU 24 loses on arbitration in transmitting the registration request command including “203” to the master ECU 10 (STEP S23). The slave ECU 21 having lost on arbitration creates the serial number “203” as an ID other than the IDs (“201” and “202”) included in the received registration request commands. Also, since the ID prepared for transmission in the slave ECU 24 having lost on arbitration is not the same as the ID included in the received registration request command, the slave ECU 24 retransmits the registration request command including “203”, without creating any other ID by counting up.

Meanwhile, the slave ECU 22 having won on arbitration keeps on retransmitting the registration request command including “201” at regular intervals until a registration completion command is received from the master ECU 10. Since the information representing that a slave ECU having the ID “201” exits was stored already in the storage unit 15 in STEP S21, at this moment, the master ECU 10 does not newly store information representing that a slave ECU having the ID “201” exists.

Thereafter, the slave ECU 22 keeps on receiving registration request commands from the other slave ECUs 21, 23, and 24. However, since the slave ECU 22 does not receive the ID “201” from the other slave ECUs 21, 23, and 24, it repeatedly transmits the same ID “201”, i.e. the ID “201” which could be transmitted, without creating any other ID (“202”, “203”, or the like) by counting up.

Next, the slave ECU 21 tries to transmit a registration request command including the ID “203” to the master ECU 10, and the slave ECU 24 tries to retransmit the registration request command including “203” to the master ECU 10.

Here, it is assumed that the slave ECU 24 could transmit the registration request command including “203” to the master ECU 10 before the slave ECU 21. In this case, the slave ECU 21 receives the registration request command including “203” and transmitted from the slave ECU 24 when it is preparing to transmit the registration request command including “203”.

In short, the slave ECU 21 loses on arbitration in transmitting the registration request command including “203” to the master ECU 10 (STEP S24). Since the ID prepared for transmission in the slave ECU 21 having lost on arbitration is the same as the ID included in the received registration request command, the slave ECU 21 creates the next serial number “204” as an ID.

Meanwhile, the slave ECU 24 having won on arbitration keeps on retransmitting the registration request command including “203” at regular intervals until a registration completion command is received from the master ECU 10. The master ECU 10 stores information representing that the slave ECU having the ID “203” exists on the network, in the storage unit 15.

Thereafter, the slave ECU 24 keeps on receiving registration request commands transmitted from the other slave ECUs 21, 22, and 23. However, since the slave ECU 24 does not receive the ID “203” from the other slave ECUs 21, 22, and 23, it repeatedly transmits the same ID “203”, i.e. the ID “203” which could be transmitted, without creating any other ID (“204” or the like) by counting up.

Next, the slave ECU 21 tries to transmit a registration request command including “204” to the master ECU 10. Since the other slave ECUs 22, 23, and 24 are continuing to transmit the registration request commands including “201”, “202”, and “203”, respectively, i.e. the registration request commands which do not include “204”, and “204” is not being transmitted from any of the slave ECUs 22, 23, and 24, the slave ECU 21 can transmit the registration request command including the ID “204” to the master ECU 10 (STEP S25).

Therefore, the slave ECU 21 keeps on retransmitting the registration request command including “204” at regular intervals until a registration completion command is received from the master ECU 10. The master ECU 10 stores information representing that the slave ECU having the ID “204” exists on the network, in the storage unit 15.

Thereafter, the master ECU 10 transmits a registration completion command to the individual slave ECUs 21, 22, 23, and 24. If the individual slave ECUs 21, 22, 23, and 24 receive the registration completion command by the receiving units 31, they store the IDs included in the registration request commands transmitted last in the storage units 35.

In the above-mentioned example, the slave ECU 21 stores “204” in the storage unit 35, and the slave ECU 22 stores “201” in the storage unit 35. Also, the slave ECU 23 stores “202” in the storage unit 35, and the slave ECU 24 stores “203” in the storage unit 35 (STEP S26).

As described above, in response to the registration instruction command instructing the slave ECUs to perform registration corresponding to the command B corresponding to discharging, the IDs “201” to “204” are assigned as IDs of the individual slave ECUs 21, 22, 23, and 24.

Also, after the ID registering process of the individual slave ECUs 21, 22, 23, and 24 finishes, for example, new slave ECUs may be additionally connected to the master ECU 10.

In this case, with respect to all slave ECUs including the slave ECUs 21, 22, 23, and 24 having existed before the addition and the added new slave ECUs, the above-mentioned ID registering process is re-performed from the beginning. Therefore, even if new slave ECUs are added, it is possible to perform assignment of IDs to individual slave ECUs with the same software.

Also, after the ID registering process finishes, for example, even if at least one slave ECU of the individual slave ECUs 21, 22, 23, and 24 is replaced, the above-mentioned ID registering process is re-performed.

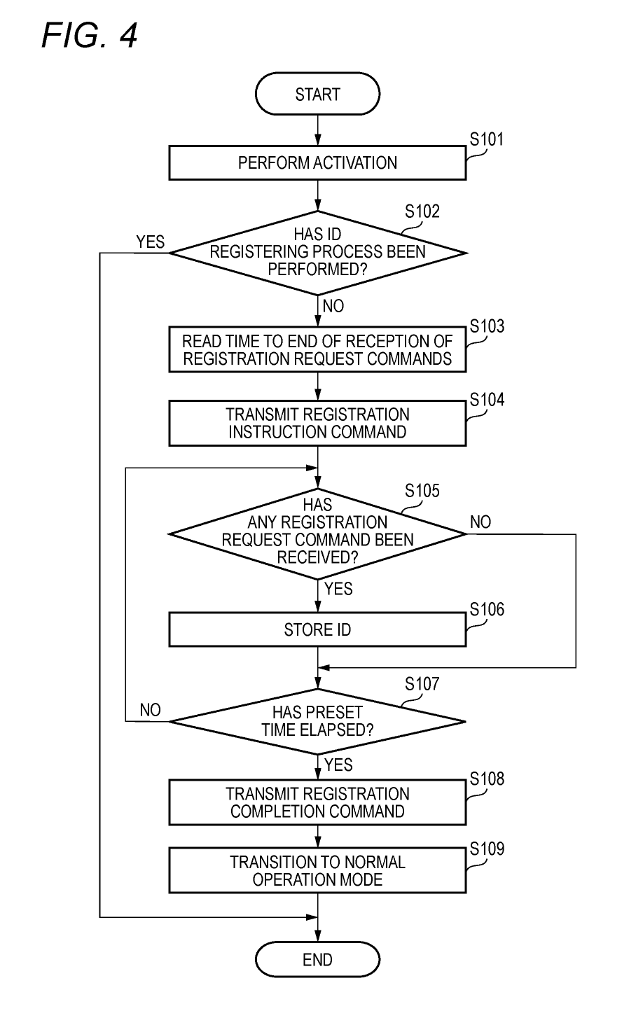

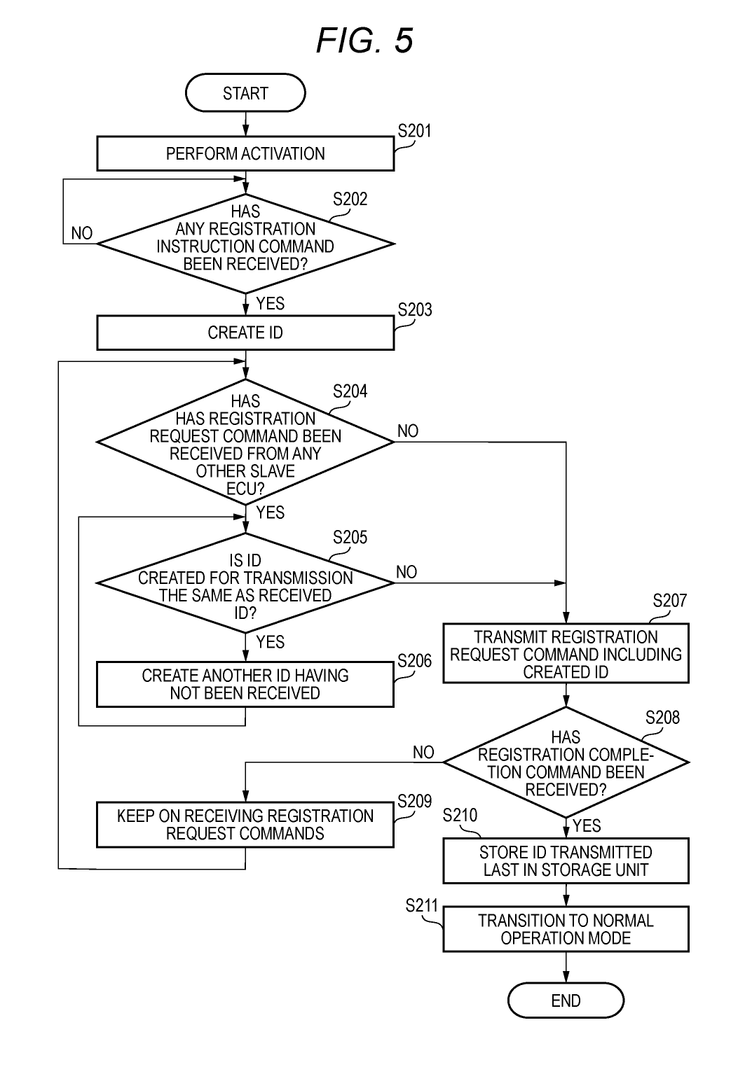

Now, with reference to FIG. 4 and FIG. 5, the procedure of the ID registering process which is performed by the communication system 1 according to the embodiment will be described. FIG. 4 and FIG. 5 are flow charts illustrating a first part and a second part of the ID registering process which is performed by the communication system 1 according to the embodiment.

First, with reference to FIG. 4, the procedure of the ID registering process which is performed in the master ECU 10 will be described.

As shown in FIG. 4, first, if an ignition switch (not shown in the drawings) is turned on, whereby power is supplied to the master ECU 10, the master ECU 10 performs an activation process such as initialization (STEP S101). Subsequently, in the master ECU 10, the determining unit 16 determines whether any ID registering process has been performed (STEP S102). In the case where the determining unit 16 determines that an ID registering process has been performed (“Yes” in STEP S102), the master ECU 10 finishes the ID registering process.

Meanwhile, in the master ECU 10, in the case where the determining unit 16 determines that any ID registering process has not been performed (“No” in STEP S102), the setting unit 17 sets a time from start of reception of registration request commands to end of reception. Specifically, the setting unit 17 reads a time to end of reception of registration request commands set in advance such that all of IDs created in the individual slave ECUs 20 can be registered in the master ECU 10, from the storage unit 15 (STEP S103).

In short, according to the maximum number of slave ECUs 20 assumed to be connected to the master ECU 10, the time to end of reception is set in advance as a time from start of reception of registration request commands to end of reception. Also, the setting unit 17 may be configured to finish reception of registration request commands even though the set time has not elapses in the case where any slave ECU 20 of the individual slave ECUs 20 is broken (a fail-safe).

Thereafter, in the master ECU 10, the instructing unit 18 commands the transmitting unit 12 to transmit a registration instruction command instructing the slave ECUs to register IDs. Subsequently, in the master ECU 10, the transmitting unit 12 transmits the registration instruction command to the individual slave ECUs 20 (STEP S104). As a result, the master ECU 10 transitions to a registration reception mode at the same time as transmission of the registration instruction command.

Subsequently, in the master ECU 10, the receiving unit 11 accepts reception of registration request commands including IDs from any one slave ECU 20 of the individual slave ECUs 20 (STEP S105). Thereafter, in the case where the master ECU 10 has received a registration request command (“Yes” in STEP S105), the storage unit 15 stores an ID included in the registration request command (STEP S106).

Meanwhile, in the case where any registration request command has not been received (“No” in STEP S05), the master ECU 10 proceeds to STEP S107.

Next, the master ECU 10 determines whether the time to end of reception of registration request commands set in advance by the setting unit 17 has elapsed (STEP S107). In the case where it is determined that the time to end of reception of registration request commands set in advance by the setting unit 17 has not elapsed (“No” in STEP S107), the master ECU 10 keeps on performing the registration request command receiving process.

Meanwhile, in the master ECU 10, in the case where it is determined that the time to end of reception of registration request commands set in advance by the setting unit 17 has elapsed (“Yes” in STEP S107), the instructing unit 18 commands the transmitting unit 12 to transmit a registration completion command representing that registration of the IDs of the individual slave ECUs 20 has been completed. Subsequently, in the master ECU 10, the transmitting unit 12 transmits the registration completion command to the individual slave ECUs 20 (STEP S108).

Thereafter, the master ECU 10 transitions from the registration reception mode to a normal operation mode (STEP S109), and finishes the process.

In the above-mentioned process of the master ECU 10, after activation of the master ECU 10, only if the ID registering process has not been performed, i.e. only during first activation of the master ECU 10, the ID registering process is performed. However, in order make it possible to newly add slave ECUs after the ID registering process, the master ECU may be configured such that an additional ID registration mode is settable.

Specifically, if the master ECU 10 transitions to the additional ID registration mode, the ID registering process is started from STEP S103. Therefore, with respect to all slave ECUs 20 including additional slave ECUs, the ID registering process is performed from the beginning. Also, transition to the additional ID registration mode can be performed according to an instruction of a tool (not shown in the drawings) by communication with the tool.

Also, if the ignition switch is turned off, IDs stored in the master ECU 10 and the slave ECUs 20 may be erased. In this case, whenever the ignition switch is turned on, whereby the master ECU 10 is activated, the ID registering process described with reference to FIG. 4 is performed. Therefore, it is also possible to easily cope with the case where slave ECUs 20 are newly added.

Now, with reference to FIG. 5, the procedure of the ID registering process which is performed in each slave ECU 20 will be described.

As shown in FIG. 5, if power is supplied, first, a slave ECU 20 performs an activation process, similarly to the master ECU 10 (STEP S201). Subsequently, in the slave ECU 20, the determining unit 37 determines whether any registration instruction command transmitted from the master ECU 10 has been received (STEP S202). In the case where the determining unit 37 determines that any registration instruction command has not been received (“No” in STEP S202), the slave ECU 20 repeatedly performs the process of STEP S202 until a registration instruction command is received.

Also, in the case where any registration instruction command has not been received from the master ECU 10 in a predetermined time, the slave ECU 20 may set an initial value (a default) set in advance, as an ID. Alternatively, in the case where any registration instruction command has not been received from the master ECU 10 in a predetermined time, the slave ECU 20 may use an ID stored in the storage unit 35 by the previous ID registering process.

Meanwhile, in the case where the determining unit 37 determines that a registration instruction command has been received (“Yes” in STEP S202), the slave ECU 20 transitions to the ID registration request mode, and the creating unit 36 creates the minimum serial number of preset serial numbers as an ID (STEP S203).

Subsequently, in the slave ECU 20, before transmission of a registration request command including the created ID, the determining unit 37 determines whether a registration request command has been received from any other slave ECU 20 (STEP S204).

In the case where the determining unit 37 determines that a registration request command has been received from any other slave ECU 20 (“Yes” in STEP S204), the slave ECU 20 performs the following process. Specifically, in the slave ECU 20, the determining unit 37 determines whether the ID included in the registration request command created for transmission is the same as an ID included in the registration request command received from another slave ECU 20 (STEP S205).

In the slave ECU 20, in the case where the determining unit 37 determines that the ID created for transmission is the same as the received ID (“Yes” in STEP S205), the instructing unit 38 instructs the creating unit 36 to create another ID having not been received (STEP S206). Specifically, the slave ECU 20 instructs the creating unit 36 to create the next serial number as an ID other than the ID included in the registration request command received from another slave ECU 20.

Also, after the creating unit 36 creates another ID having not been received, the slave ECU 20 returns to the process of STEP S205, and re-performs the process of STEP S205.

Meanwhile, in the slave ECU 20, in the case where the determining unit 37 determines that the ID created for transmission is not the same as the received ID (“No” in STEP S205), the instructing unit 38 instructs the transmitting unit 32 to transmit a registration request command including the created ID (STEP S207).

Also, even in the case where the determining unit 37 determines that a registration request command has not been received from any other slave ECU 20, in STEP S204 (“No” in STEP S204), the slave ECU 20 proceeds to the process of STEP S207. Thereafter, the slave ECU 20 performs the process of STEP S208.

Next, in the slave ECU 20, in the process of STEP S208, the determining unit 37 determines whether a registration completion command representing completion of registration of IDs of all slave ECUs 20 has received from the master ECU 10.

In the slave ECU 20, in the case where the determining unit 37 determines that a registration completion command has not been received (“No” in STEP S208), the instructing unit 38 instructs the receiving unit 31 to keep on receiving registration request commands transmitted from the other slave ECUs 20 (STEP S209). Subsequently, the slave ECU 20 returns to the process of STEP S204, and re-performs the process from the process of STEP S204.

Meanwhile, in the slave ECU 20, in the case where the determining unit 37 determines that a registration completion command has been received from the master ECU 10 (“Yes” in STEP S208), the instructing unit 38 instructs the storage unit 35 to store the ID included in the registration request command transmitted last (STEP S210).

Thereafter, the slave ECU 20 transitions from the ID registration request mode to the normal operation mode (STEP S211), and finishes the process.

The above-described communication system 1 according to the embodiment includes the master ECU 10 and the slave ECUs 20.

The master ECU 10 transmits a registration instruction command instructing the slave ECUs to register IDs. The individual slave ECUs 20 are connected to the master ECU 10 such that communication is possible, and registers IDs corresponding to the registration instruction command in the master ECU 10.

Also, each slave ECU 20 includes the creating unit 36, the instructing unit 38, and the transmitting unit 32. The creating unit 36 creates an ID corresponding to a registration instruction command. In the case where a registration completion command including the ID created by the creating unit 36 is received, the instructing unit 38 instructs the creating unit to create an ID other than the ID included in the registration request command received from another slave ECU 20. The transmitting unit 32 transmits a registration request command including the ID created by the creating unit 36 to the master ECU 10.

As described above, in the above-described communication system 1 according to the embodiment, each slave ECU 20 can create IDs by itself, and repeat ID recreation until transmission of a created ID to the master ECU 10 succeeds.

Therefore, in the above-described communication system 1 according to the embodiment, even in the case where the number of slave ECUs 20 changes, it is possible to automatically assign exclusive IDs to the individual slave ECUs 20.

In other words, according to the above-described communication system 1 of the embodiment, even in the case where the number of slave ECUs 20 changes or some slave ECUs are replaced, it is possible to perform assignment of IDs to the slave ECUs, without performing manual updating.

Also, in the above-described communication system 1 according to the embodiment, each slave ECU 20 includes the storage unit 35. Further, the instructing unit 38 instructs the transmitting unit 32 to repeatedly transmit registration request commands including IDs, and in the case where a registration completion command representing completion of registration of IDs of the individual slave ECUs 20 is received from the master ECU 10, the instructing unit instructs the storage unit 35 to store the ID transmitted last.

Therefore, in the above-described communication system 1 according to the embodiment, it is possible to store IDs corresponding to registration instruction commands in the slave ECUs 20.

Therefore, in the above-described communication system 1 according to the embodiment, it is possible to provide slave ECUs 20 having the same configuration and the same functions together, and it is possible to reduce the component cost and simplify management of the article numbers of slave ECUs 20.

Also, in the above-described communication system 1 according to the embodiment, the master ECU 10 includes the instructing unit 18. After a registration instruction command is transmitted to the slave ECUs 20, if the preset time elapses, the instructing unit 18 instructs the transmitting unit to transmit a registration completion command to the slave ECUs 20.

Therefore, in the above-described communication system 1 according to the embodiment, it is possible to reliably and efficiently register the IDs of all slave ECUs 20 in the master ECU 10.

Also, in the above-described communication system 1 according to the embodiment, if the time set in advance according to the maximum number of slave ECUs 20 assumed as a time from start of reception of registration request commands to end of reception elapses, a registration completion command is transmitted; however, the present invention is not limited to this mode.

As another mode, regardless of time, if registration of IDs of all slave ECUs 20 which are managed by the master ECU 10 is completed, a registration completion command may be transmitted.

Also, in the above-described communication system 1 according to the embodiment, the creating unit 36 of each slave ECU 20 sequentially creates preset serial numbers as IDs.

Therefore, in the above-described communication system 1 according to the embodiment, it is possible to sequentially assign serial numbers as IDs to the individual slave ECUs 20.

Also, in the above-described communication system 1 according to the embodiment, serial numbers set in advance are sequentially created as IDs at intervals of a predetermined time by counting up of a counter or the like; however, the present invention is not limited thereto.

As another mode, serial numbers set in advance may be sequentially created as IDs at intervals of a predetermined time by counting down of a counter or the like. Specifically, the creating unit 36 creates serial numbers set in advance, at intervals of the predetermined time, by counting down from the maximum serial number to the minimum serial number. Also, the creating unit 36 may create serial numbers set in advance, in random, at regular intervals of a predetermined time.

In the above-mentioned embodiment, the example in which IDs corresponding to each command are set as shown in FIG. 1B has been described. In this example, as the number of commands increases, the time required to perform the ID registering process increases. For this reason, regardless of commands, IDs of the individual slave ECUs 20 may be set.

Specifically as IDs, IDs representing the individual slave ECUs 20 regardless of the types of commands, like “01”, “02”, “03”, “04”, and so on, are registered. In the case where a command is transmitted, a code representing the type of the command (one of codes, for example, “1”, “2”, and “3” corresponding to the command A representing charging, the command B representing discharging, and the command C representing voltage measurement, respectively) may be added to IDs.

In this case, since the ID registering process needs to be performed only once, not with respect to each command, it is possible to reduce the time required to perform the ID registering process.

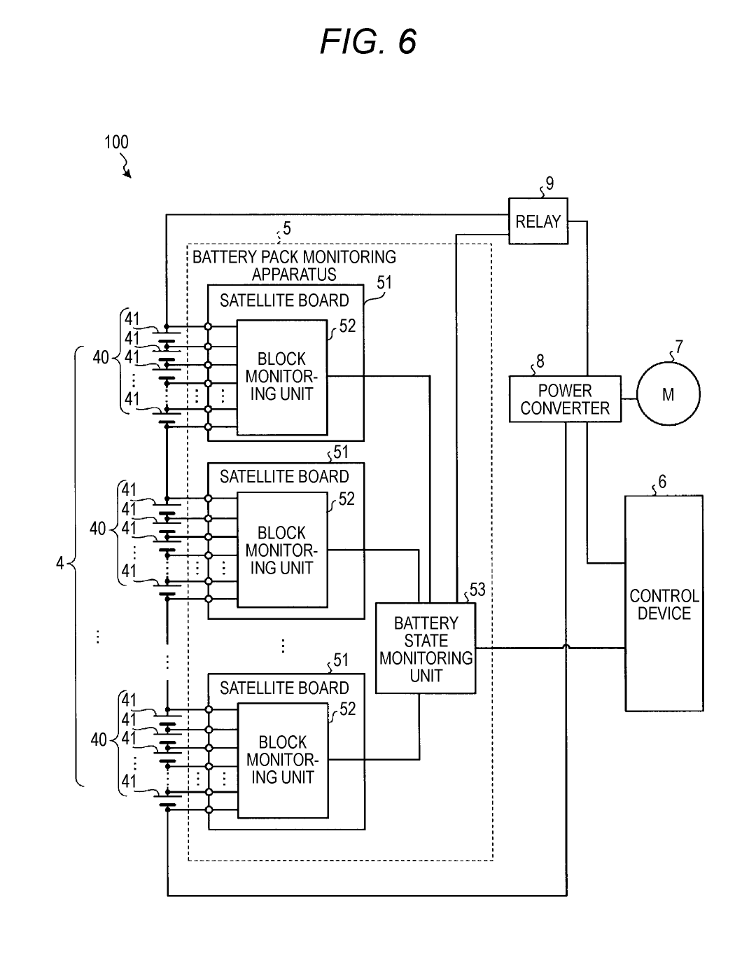

Now, with reference to FIG. 6, an example of a communication system composed of a master ECU, slave ECUs, and a control device will be described. FIG. 6 is a view illustrating a configuration example of a communication system 100 according to the embodiment. Also, in FIG. 6, the above-mentioned master ECU corresponds to a battery state monitoring unit 53, and the above-mentioned slave ECUs correspond to block monitoring units 52.

The communication system 100 can be mounted on vehicles such as a hybrid electric vehicle (HEV), an electric vehicle (EV), and a fuel cell vehicle (FCV) (not shown in the drawings).

The communication system 100 includes a battery pack 4, a battery pack monitoring apparatus 5, a control device 6, an electric motor 7, and a power converter 8, and a relay 9.

The battery pack 4 is, for example, a lithium-ion secondary battery, a nickel-hydrogen secondary battery, or the like, and is insulated from the body of a vehicle (not shown in the drawings). The battery pack 4 is configured by connecting battery blocks 40. Each battery block 40 includes battery cells 41 connected in series. Further, each battery cell 41 has a current interrupt device (not shown in the drawings) for mechanically cutting off a current path if the internal voltage rises.

The battery pack monitoring apparatus (a communication apparatus) 5 monitors the charged state and the like of the battery pack 4, and notifies the monitored states to the control device 6. The battery pack monitoring apparatus 5 includes satellite boards 51 and a battery state monitoring unit (a master ECU) 53. The satellite boards 51 have block monitoring units (slave ECUs) 52, respectively, and are individually provided for the battery blocks 40, respectively. Further, the satellite boards 51 is disposed, for example, at positions apart from one another.

The block monitoring units 52 detect the voltages of the battery blocks 40 and the battery cells 41, and detect overvoltage of the battery blocks 40, disconnection of the battery blocks 40, and the like, and notify the detection results to the battery state monitoring unit 53. Also, the block monitoring units 52 have IDs assigned according to monitoring contents of the battery cells 41 by the above-described ID registering process.

On the basis of information acquired from the block monitoring units 52 having the assigned IDs, the battery state monitoring unit 53 determines the charged state and the like of the battery pack 4. Also, the battery state monitoring unit 53 can notify the charged state and the like of the battery pack 4 to the control device 6, and turn off the relay 9 on the basis of the charged state of the battery pack 4 such that charging or discharging of the battery pack 4 is stopped. Moreover, the battery state monitoring unit 53 retains the IDs assigned to the block monitoring units 52 according to the monitoring contents of the battery cells 41 by the above-described ID registering process.

For example, in the case where any one block monitoring unit 52 of the block monitoring units 52 having the assigned IDs detects an abnormality in the charged state of a battery block 40, the battery state monitoring unit 53 can turn off the relay 9 such that charging of the battery pack 4 is stopped.

The control device 6 controls the vehicle by charging or discharging the battery pack 4 according to the charged state of the battery pack 4. For example, the control device 6 controls the power converter 8 such that the power converter performs DC-to-AC conversion on the voltage charged in the battery pack 4, and supplies the converted voltage to the electric motor 7 such that the electric motor 7 is driven. As a result, the battery pack 4 is discharged.

Also, the control device 6 controls the power converter 8 such that the power converter performs AC-to-DC conversion on the voltage generated by regenerative braking of the electric motor 7, and supplies the converted voltage to the battery pack 4. As a result, the battery pack 4 is charged. As described above, the control device 6 monitors the voltage of the battery pack 4 on the basis of the charged state of the battery pack 4 acquired from the battery pack monitoring apparatus 5, and performs control according to the monitored result.

The above-described communication system 100 according to the embodiment includes the battery pack monitoring apparatus 5 and the control device 6 for controlling the battery pack monitoring apparatus 5. The battery pack monitoring apparatus 5 automatically assigns exclusive IDs to the individual block monitoring units 52.

Therefore, in the above-described communication system 100 according to the embodiment, even in the case where battery cells 41 are newly added and block monitoring units 52 for monitoring the additional battery cells 41 are added, it is possible to perform assignment of IDs to the block monitoring units 52, without performing manual updating.

Also, the use of the communication system 100 is not particularly limited to monitoring on a battery pack installed in a vehicle, and the communication system may be used for various purposes, for example, monitoring on a device installed in a vehicle.

Also, in the above-described embodiment, the case where the communication system 100 is mounted on a vehicle has been taken as an example, however, the communication system is not limited to vehicles, and can also be mounted, for example, on airplanes, vessels, robots, and so on.

Also, in the above-described embodiment, as examples of the superordinate unit and the subordinate units, the master ECU and the slave ECUs have been taken, respectively; however, the present invention is not limited thereto, and the superordinate unit and the subordinate units may be electronic devices. In short, the present invention can be applied to everything having a hierarchical configuration in which a superordinate electronic device transmits commands to subordinate electronic devices such that the subordinate electronic devices operate.

Various advantages and modifications can be easily achieved by those skilled in the art. Therefore, the invention in its broader aspects is not limited to the specific details and representative embodiments shown and described above. Accordingly, various modifications may be made without departing from the spirit or scope of the general inventive concept as defined by the appended claims and their equivalents.

What is claimed is:

1. A communication system comprising:
a superordinate unit configured to transmit a registration instruction command instructing that identifier registration; and
subordinate units configured to be connected to the superordinate unit such that communication is possible and to register identifiers corresponding to the registration instruction command, into the superordinate unit,
wherein each of the subordinate units comprises:
a creating unit configured to create an identifier corresponding to the registration instruction command;
an instructing unit configured to instruct the creating unit to create another identifier, if a registration request command is received from another subordinate unit before a registration request command including the identifier created by the creating unit is transmitted to the superordinate unit; and
a transmitting unit configured to transmit the registration request command including the identifier created by the creating unit to the superordinate unit.

2. The communication system according to claim 1,
wherein each of the subordinate units further includes a storage unit, and
wherein the instructing unit instructs the transmitting unit to repeatedly transmit the registration request command, and if a registration completion command representing completion of registration of the identifiers of the subordinate units is received from the superordinate unit, the instructing unit instructs the storage unit to store the identifier transmitted last.

3. The communication system according to claim 2, wherein the superordinate unit includes an instructing unit configured to instruct that the registration completion command should be transmitted, if a preset time elapses after transmission of the registration instruction command to the subordinate units.

4. The communication system according to claim 1, wherein the creating unit sequentially creates the identifiers in order of preset serial numbers.

5. A communication apparatus comprising;
a creating unit configured to create an identifier;
an instructing unit configured to instruct that another identifier should be created, if a registration request command is received before a registration request command including the identifier created by the creating unit is transmitted; and
a transmitting unit configured to transmit a registration request command including the identifier created by the creating unit.

6. A communication method comprising:
creating an identifier;
instructing that another identifier should be created, if a registration request command is received before a registration request command including the identifier created by the creating process is transmitted; and
transmitting a registration request command including the identifier created by the creating process.
